(19) United States
(12) Patent Application Publication
(10) Pub. No.: US 2026/0019177 A1
(43) Pub. Date: Jan. 15, 2026

(54) HANDSHAKE MECHANISM DESIGN IN FR2 SCELL ACTIVATION

(71) Applicant: Apple Inc., Cupertino, CA (US)

(72) Inventors: Qiming Li, Beijing (CN); Jie Cui, Saratoga, CA (US); Yuqin Chen, Beijing (CN); Manasa Raghavan, Sunnyvale, CA (US); Yuexia Song, Beijing (CN); Yang Tang, San Jose, CA (US); Rolando E Bettancourt Ortega, Munich (DE); Hong He, San Jose, CA (US); Dawei Zhang, Saratoga, CA (US); Xiang Chen, Pal Alto, CA (US)

(21) Appl. No.: 18/993,905

(22) PCT Filed: Aug. 4, 2022
(86) PCT No.: PCT/CN2022/110175

§ 371 Date: Jan. 13, 2025

(51) Int. Cl. H04B 17/318; H04B 7/06; H04W 72/21; H04W 76/20

(52) U.S. Cl. CPC H04B 17/328; H04B 7/0632; H04W 72/21; H04W 76/20

(57) ABSTRACT

Handshake mechanism design in Frequency Range 2 (FR2) SCell activation is disclosed. A user equipment (UE) may be configured to send, to a network, a ready indication that the UE is ready to perform Layer 1-Reference Signal Receiving Power (L1-RSRP)/beam (BM) measurement and receive a L1-RSRP measurement/BM Reference Signal (RS) from the network.

### TECHNICAL FIELD

This disclosure relates generally to wireless communication systems, including handshake mechanism design in Frequency Range 2 (FR2) Secondary Cell (SCell) activation.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### SUMMARY OF THE INVENTION

This disclosure is directed to enhancements to FR2 SCell activation. Specifically, devices and methods are provided with a handshake mechanism in FR2 SCell activation.

According to some aspects, a user equipment (UE) is provided. The UE comprises: at least one antenna; at least one radio coupled to the at least one antenna; and a processor coupled to the at least one radio; wherein the processor is configured to, during FR2 Secondary Cell (SCell) activation: send, to a network, a ready indication that the UE is ready to perform Layer 1-Reference Signal Receiving Power (L1-RSRP) measurement/beam measurement (BM); and receive a L1-RSRP measurement/BM Reference Signal (RS) from the network.

According to some aspects, a method is provided. The method comprises: by a UE and during FR2 SCell activation, sending, to a network, a ready indication that the UE is ready to perform L1-RSRP measurement/BM; and receiving a L1-RSRP measurement/BM RS from the network.

According to some aspects, a base station (BS) is provided. The BS comprises: at least one antenna; at least one radio coupled to the at least one antenna; and a processor coupled to the at least one radio; wherein the processor is configured to, during FR2 SCell activation: receive from a UE, a ready indication that the UE is ready to perform L1-RSRP measurement/BM; and after receiving the ready indication, transmit a L1-RSRP measurement/BM RS to the UE for use with L1-RSRP measurement/BM.

According to some aspects, a method is provided. The method comprises: by a BS and during FR2 SCell activation, receiving from a UE, a ready indication that the UE is ready to perform L1-RSRP measurement/BM; and after receiving the ready indication, transmit a L1-RSRP measurement/BM RS to the UE for use with L1-RSRP measurement/BM.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an example classification for existing FR2 SCell activation scenarios, according to embodiments disclosed herein.

FIG. 4 illustrates an exemplary SCell activation, according to embodiments disclosed herein.

FIG. 5 illustrates a method for performing handshake between a UE and a network to which the UE is connected, according to embodiments disclosed herein.

FIG. 6 illustrates a method for performing handshake between a UE and a network to which the UE is connected, according to embodiments disclosed herein.

FIG. 7 illustrates an exemplary SCell activation procedure including a ready indication, according to embodiments disclosed herein.

FIG. 8 illustrates another exemplary SCell activation procedure including a ready indication, according to embodiments disclosed herein.

FIG. 9 illustrates another exemplary SCell activation procedure including a ready indication, according to embodiments disclosed herein.

FIG. 10 illustrates another exemplary SCell activation procedure including a ready indication, according to embodiments disclosed herein.

FIG. 11 illustrates another exemplary SCell activation procedure including a ready indication, according to embodiments disclosed herein.

### DETAILED DESCRIPTION

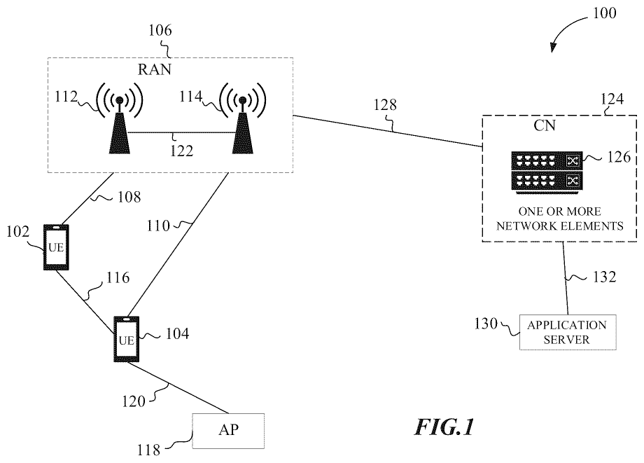

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VOIP sessions, group communication sessions, etc.) for the UE 102 and UE 104 via the CN 124. The application server 130 may communicate with the CN 124 through an IP communications interface 132.

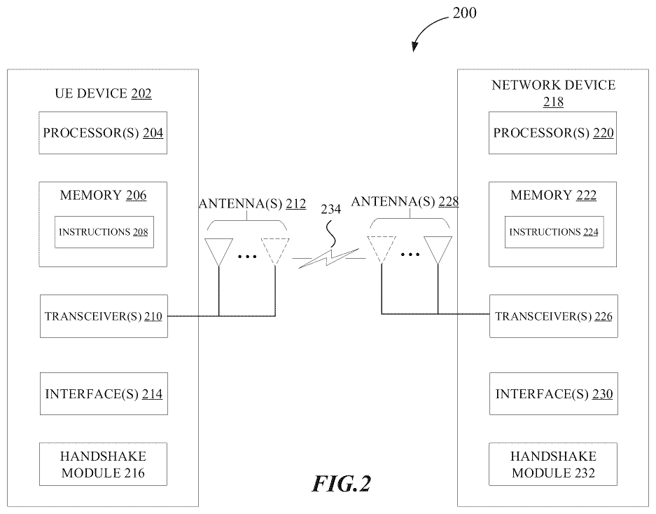

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The wireless device 202 may include a handshake module 216. The handshake module 216 may be implemented via hardware, software, or combinations thereof. For example, the handshake module 216 may be implemented as a processor, circuit, and/or instructions 208 stored in the memory 206 and executed by the processor(s) 204. In some examples, the handshake module 216 may be integrated within the processor(s) 204 and/or the transceiver(s) 210. For example, the handshake module 216 may be implemented by a combination of software components (e.g., executed by a DSP or a general processor) and hardware components (e.g., logic gates and circuitry) within the processor(s) 204 or the transceiver(s) 210.

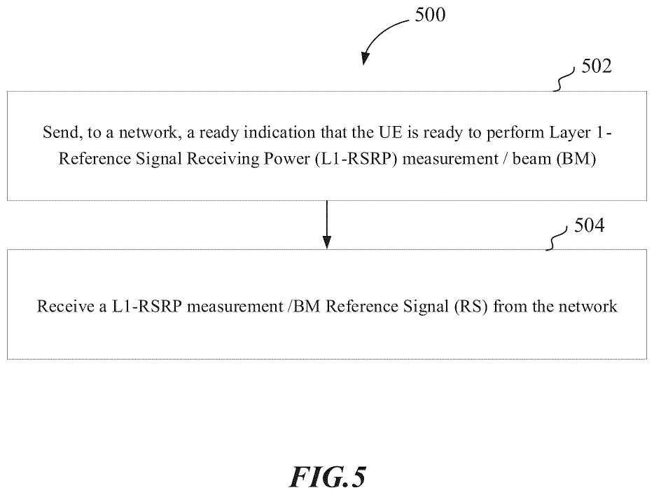

The handshake module 216 may be used for various aspects of the present disclosure, for example, for implementing the handshake mechanism described in aspects of FIGS. 5-9. The handshake module 216 is configured to perform the handshake process at the UE side.

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

The network device 218 may include a handshake module 232. The handshake module 232 may be implemented via hardware, software, or combinations thereof. For example, the handshake module 232 may be implemented as a processor, circuit, and/or instructions 224 stored in the memory 222 and executed by the processor(s) 220. In some examples, the handshake module 232 may be integrated within the processor(s) 220 and/or the transceiver(s) 226. For example, the handshake module 232 may be implemented by a combination of software components (e.g., executed by a DSP or a general processor) and hardware components (e.g., logic gates and circuitry) within the processor(s) 220 or the transceiver(s) 226.

The handshake module 232 may be used for various aspects of the present disclosure, for example, for implementing the handshake mechanism described in aspects of FIGS. 5-9. The handshake module 232 is configured to perform the handshake process at the network side.

The disclosure herein considers FR2 SCell activation delay reduction. It is observed that some of the FR2 RRM requirements allow excessively long delay for UE in certain RRM operations. It is also observed that there are feasible ways to enhance specific requirements to guarantee fair performance in the field for FR2 networks, e.g., FR2 SCell activation delay requirement.

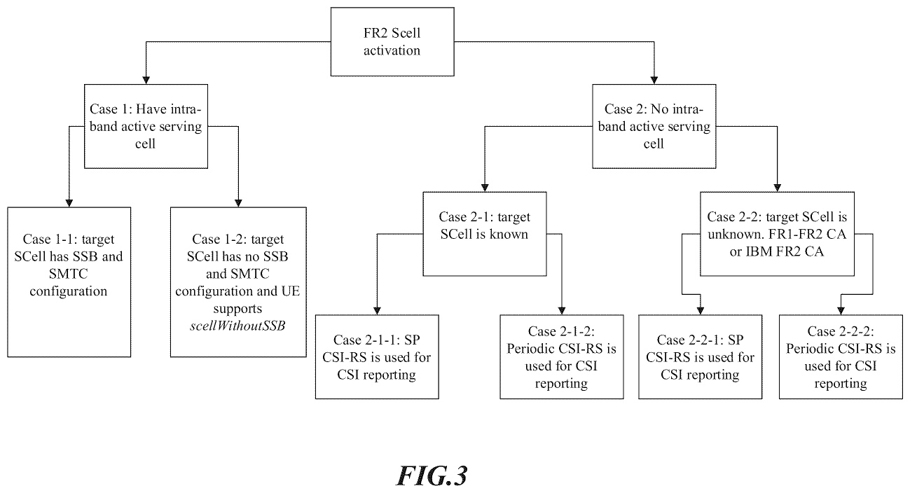

FIG. 3 illustrates an example classification for existing FR2 SCell activation scenarios. Existing FR2 SCell activation scenarios may be classified into: Case 1 in which the SCell being activated belongs to FR2 and there is at least one active serving cell on that FR2 band; or Case 2 in which the SCell being activated belongs to FR2 and there is no active serving cell on that FR2 band.

Existing FR2 SCell activation scenarios in Case 1 can be further classified into: Case 1-1 in which the UE has SSB and SS/PBCH block measurement timing configuration (SMTC) configuration; or case 1-2 in which the UE has no SSB/SMTC configuration and supports scellWithoutSSB.

Existing FR2 SCell activation scenarios in Case 2 can be further classified into: Case 2-1 in which the target SCell is known to UE; or Case 2-2 in which the target SCell is unknown to the UE and the PCell/PSCell and the target SCell are configured as FR1-FR2 Carrier Aggregation (CA) or if the PCell/PSCell and the target SCell are in a FR2 band pair with independent beam management.

Existing FR2 SCell activation scenarios in Case 2-1 can be further classified into: Case 2-1-1 in which semi-persistent (SP) CSI-RS is used for CSI reporting; or Case 2-1-2 in which periodic CSI-RS is used for CSI reporting.

Existing FR2 SCell activation scenarios in Case 2-2 can be further classified into: Case 2-2-1 in which semi-persistent CSI-RS is used for CSI reporting; or Case 2-2-2 in which periodic CSI-RS is used for CSI reporting.

Table 1 shows requirements for T_{activation_time} for all these cases shown in FIG. 3. T_{activation_time} is the SCell activation delay in millisecond, from decoding of a MAC CE for SCell activation to the reporting of CSI.

TABLE 1

| Case ID | requirements for T_{activation}_{_{—}}ₜᵢₘₑ |
|---|---|
| Case 1-1 | T_{FirstSSB} + 5 ms |
| Case 1-2 | 3 ms |
| Case 2-1-1 | 3 ms + max(T_{uncertainty}_{_{—}}_{MAC} + T_{FineTiming} + 2 ms, |
| | T_{uncertainty}_{_{—}}_{SP}) |
| Case 2-1-2 | max (T_{uncertainty}_{_{—}}_{MAC} + 5 ms + T_{FineTiming}, T_{uncertainty}_{_{—}}_{RRC} + |
| | T_{RRC}_{_{—}}_{delay} − T_{HARQ}) |
| Case 2-2-1 | 6 ms + T_{FirstSSB}_{_{—}}_{MAX} + 15*T_{SMTC}_{_{—}}_{MAX} + 8*Tᵣₛ + |
| | T_{L1-RSRP, measure} + T_{L1-RSRP, report} + T_{HARQ} + |
| | max(T_{uncertainty}_{_{—}}_{MAC} + T_{FineTiming} + 2 ms, T_{uncertainty}_{_{—}}_{SP}) |
| Case 2-2-2 | 3 ms + T_{FirstSSB}_{_{—}}_{MAX} + 15*T_{SMTC}_{_{—}}_{MAX} + 8*Tᵣₛ + |
| | T_{L1-RSRP, measure} + T_{L1-RSRP, report} + max {(T_{HARQ} + |
| | T_{uncertainty}_{_{—}}_{MAC} + 5 ms + T_{FineTiming}), (T_{uncertainty}_{_{—}}_{RRC} + |
| | T_{RRC}_{_{—}}_{delay})}. |

For example, for Case 1-1, T_{activation_time} is T_{FirstSSB}+5 ms, wherein T_{FirstSSB} may be the time to the end of the first complete SSB burst indicated by the SMTC, or within 5 ms if SMTC is not configured.

For case 2-2-1, T_{activation_time} is 6 ms+T_{FirstSSB_MAX}+15*T_{SMTC_MAX}+8*Tᵣₛ+T_{L1-RSRP, measure}+T_{L1-RSRP, report}+T_{HARQ}+max(T_{uncertainty_MAC}+T_{FineTiming}+2 ms, T_{uncertainty_SP}).

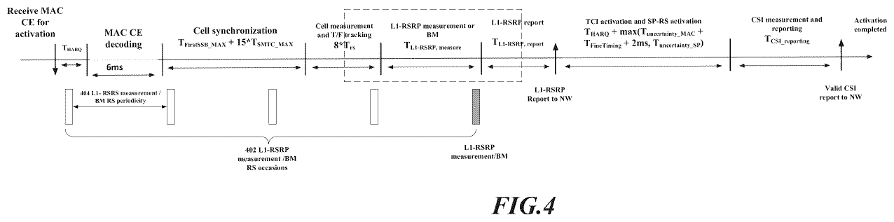

FIG. 4 illustrates an exemplary SCell activation procedure for case 2-2-1. As shown in FIG. 4, the SCell activation procedure includes a plurality of working parts, such as HARQ, MAC CE decoding, cell synchronization, cell measurement and T/F tracking, L1-RSRP measurement or beam measurement (BM), L1-RSRP report, TCI activation and SP-RS activation, CSI measurement and reporting.

As shown in FIG. 4, the SCell activation procedure starts upon receipt of MAC CE for the SCell activation, then includes a time period T_{HARQ} (in ms) which may be the timing between DL data transmission and acknowledgement.

Then, the cell synchronization is performed, and the time period related with the cell synchronization is T_{FirstSSB_MAX}+15*T_{SMTC_MAX}, wherein T_{FirstSSB_MAX} may be the time to the end of the first complete SSB burst indicated by the SMTC, or within 5 ms if SMTC is not configured, when all active serving cells and SCells being activated or released are transmitting SSB bursts in the same slot.

Following that, cell measurement and Time/Frequency tracking is performed and a corresponding time period is 8*Tᵣₛ, wherein Tᵣₛ may be a time related with SMTC configuration.

After that, L1-RSRP measurement or beam measurement is performed to determine the best beam, and a corresponding time period is T_{L1-RSRP, measure}, which may be the L1-RSRP measurement delay.

Then, L1-RSRP report is performed to report to the network the best beam and the completion of L1-RSRP measurement or beam measurement, and a corresponding time period is T_{L1-RSRP, report}, which may be delay of acquiring CSI reporting resources.

After that, the network schedules Transmission Configuration Indicator (TCI) and Semi-persist Reference Signals (SP RS) for the UE. TCI activation and SP-RS activation for Channel State Information (CSI) reporting is performed, and a corresponding time period is T_{HARQ}+max(T_{uncertainty_MAC}+T_{FineTiming}+2 ms, T_{uncertainty_SP}). T_{uncertainty_MAC} may be the time period between reception of the last activation command for Physical Downlink Control Channel (PDCCH) TCI, Physical Downlink Shared CHannel (PDSCH) TCI (when applicable) relative to SCell activation command for known case or first valid L1-RSRP reporting for unknown case. T_{FineTiming} may be the time period between UE finish processing the last activation command for PDCCH TCI, PDSCH TCI (when applicable) and the timing of first complete available SSB corresponding to the TCI state. T_{uncertainty_SP} may be the time period between reception of the activation command for semi-persistent CSI-RS resource set for CQI reporting relative to SCell activation command for known case, or first valid L1-RSRP reporting for unknown case.

For case 2-1-2, T_{activation_time} is 3 ms+T_{FirstSSB_MAX}+15*T_{SMTC_MAX}+8*Tᵣₛ+T_{L1-RSRP, measure}+T_{L1-RSRP, report}+max {(T_{HARQ}+T_{uncertainty_MAC}+5 ms+T_{FineTiming}), (T_{uncertainty_RRC}+T_{RRC_delay})}. T_{uncertainty_RRC} may be the time period between reception of the RRC configuration message for TCI of periodic CSI-RS for CQI reporting (when applicable) relative to SCell activation command for known case, or first valid L1-RSRP reporting for unknown case. T_{RRC_delay} is the RRC procedure delay.

Typically, the L1-RSRP measurement/BM is performed by use of L1-RSRP/BM RS that is transmitted between the network and the UE. The L1-RSRP measurement/BM is supposed to be performed after the UE completes cell synchronization and cell measurement. In existing systems, the network has no idea how fast the UE can perform cell synchronization and cell measurement. As such, the network is typically designed to configure L1-RSRP measurement/BM RS occasions (at which L1-RSRP measurement/BM RS will be transmitted between the network and the UE) in a periodic way, so that at least one of the periodically transmitted L1-RSRP measurement/BM RS might be used by the UE. As is shown in FIG. 4, five L1-RSRP/BM RS occasions 402 are scheduled with a specified L1-RSRP/BM RS periodicity 404.

Typically, the network is designed to configure eight resources periodically (with small periodicity). Such configuration is performed before the FR2 SCell activation. Consequently, the L1-RSRP measurement delay will be impacted by the L1-RSRP measurement/BM RS periodicity. Also, each L1-RSRP measurement/BM RS that is transmitted before UE is ready for L1-RSRP measurement/BM may be wasted. As is shown in FIG. 4, only the fifth L1-RSRP measurement/BM RS occasion (shown by the darkened block) will be actually used by the UE for L1-RSRP measurement/BM. The first four L1-RSRP measurement/BM RS will not be used by the UE because the UE is not ready to conduct L1-RSRP measurement/BM at those L1-RSRP measurement/BM RS occasions.

The disclosure herein considers enhancements to L1-RSRP measurement/BM in FR2 SCell activation. Specifically, devices and methods are provided with a handshake mechanism via a ready indication. The handshake mechanism allows the network to understand when the cell synchronization and measurement is completed at the UE. Based on the indication, the network may flexibly configure or activate or transmit the L1-RSRP measurement/BM RS for UE to perform L1-RSRP measurement/BM. With the disclosed mechanism, L1-RSRP measurement/BM may be more flexible, and the associated resources may be reduced.

FIG. 5 illustrates a method 500 for performing handshake between a UE and a network to which the UE is connected, according to embodiments disclosed herein. The method 500 may be performed by the UE or a module of the UE. For example, the method 500 may be performed by the handshake module 216 of the wireless device 202 as described above.

The method 500 may start with step 502. In this step, the UE may be configured to send, to the network, a ready indication that the UE is ready to perform L1-RSRP measurement/BM. The ready indication allows the network to understand when the UE is ready. The ready indication may be sent in a variety of manners, as will be discussed below.

The UE may be configured to determine the UE is ready to perform L1-RSRP measurement/BM based on various conditions. In an embodiment, the UE may be configured to determine that the UE is ready to perform L1-RSRP measurement/BM upon completion of cell synchronization and cell measurement during the FR2 SCell activation. In another embodiment, the UE may be configured to wait for a specified amount of time after completion of cell synchronization and cell measurement and then determine that the UE is ready to perform L1-RSRP measurement/BM. Other embodiments may also be possible.

The method 500 may proceed then to step 504. In this step, the UE may be configured to receive a L1-RSRP measurement/BM RS from the network. The L1-RSRP measurement/BM RS received by the UE may be a periodic reference signal (P-RS), an aperiodic reference signal (AP-RS), a semi-persistent reference signal (SP-RS), or any other suitable RS for L1-RSRP measurement/BM. The L1-RSRP measurement/BM RS may be configured, transmitted or activated by the network in response to the ready indication. Upon receiving the L1-RSRP measurement/BM RS, the UE may be configured to perform L1-RSRP measurement/BM using the received L1-RSRP measurement/BM RS.

In embodiments where P-RS is used for L1-RSRP measurement/BM, the UE may receive, from the BS, configuration of the P-RS before receiving the P-RS from the BS. Such configuration, for example, may be performed by the BS after the BS receives the ready indication. The UE may then receive the configured P-RS from the BS.

In embodiments where SP-RS is used for L1-RSRP measurement/BM, the UE may receive, from the BS, configuration and/or activation of the SP-RS before receiving the P-RS from the BS. Such configuration and/or activation, for example, may be performed by the BS after the BS receives the ready indication. The UE may then receive the configured/activated P-RS from the BS.

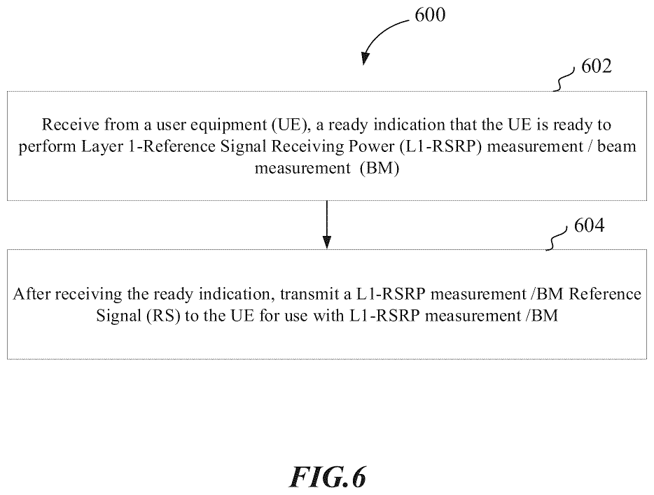

FIG. 6 illustrates a method 600 for performing handshake between a UE and a network to which the UE is connected, according to embodiments disclosed herein. The method 600 may be performed on the network side, such as, by a BS or a module of the BS. For example, the method 600 may be performed by the handshake module 232 of the network device 218 as described above.

The method 600 may start with step 602. In this step, the BS may be configured to receive from a UE, a ready indication that the UE is ready to perform L1-RSRP/BM measurement. The BS may be configured to interpret a variety of signaling from the US as the ready indication, as will be discussed below.

After the BS receiving the ready indication from the UE, the method 600 may proceed to step 604. In this step, the BS may be configured to transmit a L1-RSRP measurement/BM RS to the UE for use with L1-RSRP measurement/BM.

In some embodiments, the L1-RSRP measurement/BM RS transmitted by the BS may be a periodic reference signal (P-RS). In an embodiment, the P-RS may have been configured before the SCell activation, but will be transmitted after the BS has received the ready indication from the UE. In another embodiment, instead of being configured before the SCell activation, the P-RS may be configured by the BS after the BS has received the ready indication from the UE, and then be transmitted by the BS to the UE according to the configuration.

In other embodiments, the L1-RSRP measurement/BM RS transmitted by the BS may be a semi-persistent reference signal (SP-RS). In an embodiment, the SP-RS may be configured before the SCell activation and activated before the BS has received the ready indication. In this case, the BS may transmit the activated SP-RS after receiving the ready indication. In another embodiment, the SP-RS may be configured before the SCell activation, but are activated and transmitted by the BS after the BS has received the ready indication from the UE. In a further embodiment, instead of being configured before the SCell activation, the SP-RS may be configured by the BS after the BS has received the ready indication from the UE, and then be activated and transmitted to the UE.

In further embodiments, the L1-RSRP measurement/BM RS transmitted by the BS may be an aperiodic reference signal (AP-RS). The BS may transmit the AP-RS to the UE after receiving the ready indication. Other types of RS may be alternatively used.

The methods 500 or 600 may allow the UE and the BS to perform a handshake process regarding whether the UE is ready to perform L1-RSRP measurement/BM. With this handshake process, the BS may use L1-RSRP measurement/BM RS in a more flexible manner than the existing periodic L1-RSRP measurement/BM RS. As described above, instead of being configured before the FR2 SCell activation, the L1-RSRP measurement/BM RS disclosed herein may be configured, activated, and/or transmitted based on receiving the ready indication from the UE.

The ready indication sent between the UE and the network may be embodied via various signaling from the UE to the BS.

According to some embodiments, the ready indication may be embodied as an out-of-range (OOR) report from the UE to the BS. In this embodiment, the OOR may not be reported from the UE to the network before the UE is ready to perform L1-RSRP measurement/BM.

Typically, the OOR serves as an indication to the network that the UE is still undergoing the FR2 SCell activation. In existing systems, starting from slot n+T_{HARQ}+3 ms (where slot n is the slot where SCell activation command is received) till completion of the SCell activation at the UE and after at least one Channel State Information-Reference Signal (CSI-RS) transmission occasion for the channel measurement and reporting, the UE shall report OOR to the BS if the UE has available uplink resources to report CQI for the SCell. In other words, during the FR2 SCell activation, the OOR is typically reported during a time period that starts from at least one CSI-RS transmission occasion and ends at completion of the SCell activation at the UE. The CSI-RS transmission occasion usually occurs before the UE becomes ready for L1-RSRP measurement/BM.

According to embodiments disclosed herein, the OOR may be modified to serve as the ready indication. For example, the UE may be configured to report the OOR to the BS only after the UE is ready to perform L1-RSRP measurement/BM. That is, the UE may not report the OOR before the UE is ready to perform L1-RSRP measurement/BM. As such, the OOR that is reported from the UE to the BS may serve as the ready indication that the UE is ready to perform L1-RSRP measurement/BM. Accordingly, the BS may be configured to assume the UE is ready to perform L1-RSRP measurement/BM upon receiving the OOR from the UE. More specifically, the first OOR reported from the UE to the BS could be the initial ready indication.

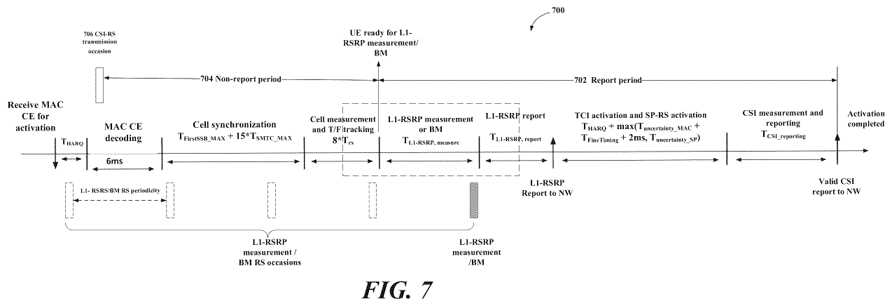

FIG. 7 illustrates an exemplary SCell activation procedure 700 including a ready indication, according to embodiments disclosed herein.

As is shown in FIG. 7, The UE may be configured to report the OOR to the BS during the report period 702. The report period 702 may start when the UE becomes ready to perform L1-RSRP measurement/BM. For example, the report period 702 may start when the cell measurement of the UE is complete. Before the cell measurement of the UE is complete, the UE may be configured to not report the OOR to the BS. For example, the UE may be configured to not report the OOR during the non-report period 704, which starts at an exemplary CSI-RS transmission occasion 706 till the UE becomes ready to perform L1-RSRP measurement/BM. As such, the OOR reported during the report period 702 may be interpreted as the ready indication to the BS that the UE is ready to perform L1-RSRP measurement/BM. Upon receiving the reported OOR, the BS may accordingly configure, activate or transmit a respective L1-RSRP measurement/BM RS to the UE.

According to alternative embodiments, the ready indication may be embodied as a lowest valid L1 Synchronization Signal Reference Signal Received Power (SS-RSRP) range reported from the UE to the BS, and the lowest valid SS-RSRP range is not reported to the network before the UE is ready to perform L1-RSRP measurement/BM.

Typically, the lowest valid L1 SS-RSRP range serves as an indication to the network that the UE has not yet finished its first L1-RSRP measurement. In existing systems, starting from the slot specified as timing for secondary Cell activation/deactivation until the UE has completed a first L1-RSRP measurement, the UE shall periodically report the lowest valid L1 SS-RSRP range if the UE has available uplink resources to report L1-RSRP for the SCell.

According to embodiments disclosed herein, the lowest valid L1 SS-RSRP range may be modified to serve as the ready indication. For example, the UE may be configured to report the lowest valid L1 SS-RSRP range to the BS only after the UE is ready to perform L1-RSRP measurement/BM. That is, the UE may not report the lowest valid L1 SS-RSRP range to the BS before the UE is ready to perform L1-RSRP measurement/BM. As such, the lowest valid L1 SS-RSRP range that is reported from the UE to the BS may serve as the ready indication that the UE is ready to perform L1-RSRP measurement/BM. Accordingly, the BS may be configured to assume the UE is ready to perform L1-RSRP measurement/BM upon receiving the lowest valid L1 SS-RSRP range from the UE. More specifically, the first lowest valid L1 SS-RSRP range reported from the UE to the BS could be the initial ready indication. The lowest valid L1 SS-RSRP range may be periodically reported.

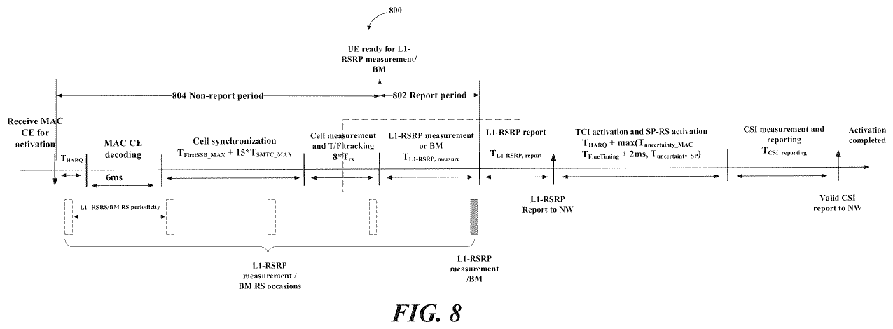

FIG. 8 illustrates another exemplary SCell activation procedure 800 including a ready indication, according to embodiments disclosed herein.

As is shown in FIG. 8, The UE may be configured to report the lowest valid L1 SS-RSRP range to the BS during the report period 802. The report period 802 may start when the UE becomes ready to perform L1-RSRP measurement/BM. For example, the report period 802 may start when the cell measurement of the UE is complete and ends when UE has finished its first L1-RSRP measurement. Before the cell measurement of the UE is complete, the UE may be configured to not report the lowest valid L1 SS-RSRP range to the BS. For example, the UE may be configured to not report the lowest valid L1 SS-RSRP range during the non-report period 804, which starts at the slot specified as timing for secondary Cell activation/deactivation and ends when the UE becomes ready to perform L1-RSRP measurement/BM. As such, the lowest valid L1 SS-RSRP range reported during the report period 802 may be interpreted as the ready indication to the BS that the UE is ready to perform L1-RSRP measurement/BM. Upon receiving the reported lowest valid L1 SS-RSRP range, the BS may accordingly configure, activate or transmit a respective L1-RSRP measurement/BM RS to the UE.

According to alternative embodiments, the ready indication may be embodied as a valid CQI reported from the UE to the BS, and the valid CQI is reported to the network once the UE is ready to perform L1-RSRP measurement/BM.

Typically, a valid CQI serves as an indication to the network that the UE has complete the SCell activation. In existing systems, the UE shall report an invalid CQI (e.g., the OOR that indicates CQI=0) to the BS before the activation is complete and report a valid CQI when the activation is complete.

According to embodiments disclosed herein, the UE may be configured to report valid CQI to the BS after the UE is ready to perform L1-RSRP measurement/BM. That is, the UE does not wait until the activation is complete to report the valid CQI, but instead report a valid CQI after the UE becomes ready to perform L1-RSRP measurement/BM. As such, the valid CQI that is reported from the UE to the BS may serve as the ready indication that the UE is ready to perform L1-RSRP measurement/BM. Accordingly, the BS may be configured to assume the UE is ready to perform L1-RSRP measurement/BM upon receiving the valid CQI from the UE.

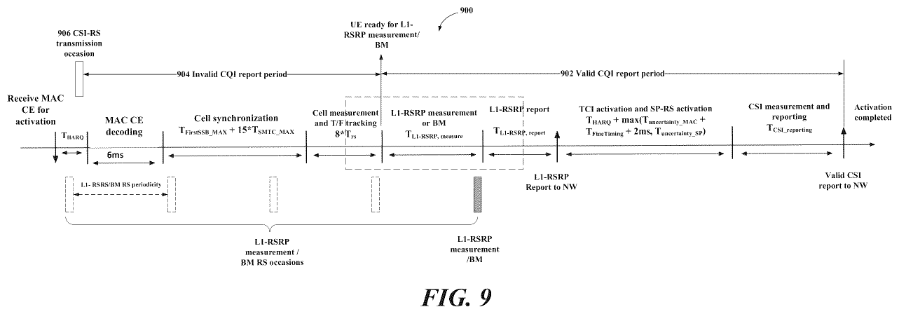

FIG. 9 illustrates another exemplary SCell activation procedure 900 including a ready indication, according to embodiments disclosed herein.

As is shown in FIG. 9, the UE may be configured to report the valid CQI to the BS during the valid CQI report period 902. The valid CQI report period 902 may start when the UE becomes ready to perform L1-RSRP measurement/BM. For example, the valid CQI report period 902 may start when the cell measurement of the UE is complete and ends when UE has completed SCell activation. Before the cell measurement of the UE is complete, the UE may be configured to report an invalid CQI to the BS. For example, the UE may be configured to report the invalid CQI during the invalid CQI report period 904, which starts at an exemplary CSI-RS transmission occasion 906 and ends when the UE becomes ready to perform L1-RSRP measurement/BM. As such, the valid CQI reported during the valid CQI report period 902 may be interpreted as the ready indication to the BS that the UE is ready to perform L1-RSRP measurement/BM. Upon receiving the reported valid CQI, the BS may accordingly configure, activate or transmit a respective L1-RSRP measurement/BM RS to the UE.

In some embodiments, the invalid CQI reported during the invalid CQI report period 904 may have CQI=0, which is the typical OOR.

In some embodiments, the valid CQI reported during the valid CQI report period 902 may be a specific CQI index. The specific CQI index may be known to both the network and the UE.

In an embodiment, the network may preconfigure a specific CQI index as a special ready indication for handshake purpose. For example, CQI=3 (or any other suitable value) may be preconfigured by the network as a special handshake flag that will be reported to the BS only when the UE becomes ready to perform L1-RSRP measurement/BM. In some examples, the network may be able to preconfigure a respective specific CQI index used for the handshake purpose with a respective UE.

In another embodiment, a predefined CQI index may be used as the ready indication. For example, the highest CQI index in the CQI range used in the network may be deemed as the ready indication. For another example, the lowest CQI index (except for 0, which is used by the OOR) in the CQI range used in the network may be deemed as the ready indication. The CQI range used in the network may be predefined in the communication standards or specifications. Also, the predefined CQI index used for the handshake purpose may be specified in the communication standards or specifications. For example, the predefined CQI index may be specified as a fixed value.

In yet another embodiment, a new CQI index may be dedicatedly defined and used for the ready indication.

In the above embodiments, if the BS receives this preconfigured, predefined or dedicatedly defined specific CQI index from the UE, the BS may assume that the UE becomes ready for L1-RSRP measurement/BM.

In alternative embodiments, the valid CQI reported during the valid CQI report period 902 may be a random CQI index within the CQI range used in the network. If the BS receives any CQI index that is within the CQI range, the BS may assume that the UE becomes ready for L1-RSRP measurement/BM. The CQI range used in the network may be defined in the communication standards or specifications. In one aspect, the random CQI index may not be zero. In this case, any CQI index that is within the CQI range and is not zero will serve as the ready indication.

According to alternative embodiments, the ready indication may be embodied as a valid result of L1-RSRP measurement/BM reported from the UE to the BS, and the valid result of L1-RSRP measurement/BM is not based on measurement of an actual L1-RSRP measurement/BM RS from the network.

Typically, a valid result of L1-RSRP measurement/BM is obtained by the UE when the UE completes at least its first L1-RSRP measurement/BM. Accordingly, the valid result of L1-RSRP measurement/BM is typically reported to the BS after UE completes at least its first L1-RSRP measurement/BM.

According to embodiments disclosed herein, however, the UE may be configured to report a valid result of L1-RSRP measurement/BM to the BS before UE completes its first L1-RSRP measurement/BM. Specifically, the valid result of L1-RSRP measurement/BM may be reported once the UE becomes ready to perform L1-RSRP measurement/BM. Because the UE has not performed an actual L1-RSRP measurement/BM at the time it becomes ready to perform L1-RSRP measurement/BM, the reported valid result of L1-RSRP measurement/BM may not be based on an actual measurement of any physical L1-RSRP measurement/BM RS. Instead, the reported valid result of L1-RSRP measurement/BM may simply take the form of L1-RSRP report but actually serve as a ready indication that the UE is ready for L1-RSRP measurement/BM.

In some embodiments, the valid result of L1-RSRP measurement/BM serving as the ready indication may be a specific L1-RSRP range. The specific L1-RSRP range may be known to both the network and the UE.

In an embodiment, the network may preconfigure a specific L1-RSRP range as a ready indication, which will be reported to the BS only when the UE becomes ready to perform L1-RSRP measurement/BM. In some examples, the network may be able to preconfigure a respective specific L1-RSRP range used for the handshake purpose with a respective UE.

In another embodiment, a predefined L1-RSRP range may be used as the ready indication. The predefined L1-RSRP range may be selected from all possible L1-RSRP ranges used in the network All possible L1-RSRP ranges used in the network may be defined in the communication standards or specifications. Also, the predefined L1-RSRP range used for the handshake purpose may be specified in the communication standards or specifications. For example, the predefined L1-RSRP range may be specified as a fixed L1-RSRP range.

In yet another embodiment, a new L1-RSRP range may be dedicatedly defined and used for the ready indication.

In the above embodiments, if the BS receives this preconfigured, predefined or dedicatedly defined specific L1-RSRP range as a valid result of L1-RSRP measurement/BM from the UE, the BS may assume that this range indicates the UE becomes ready for L1-RSRP measurement/BM, instead of being an actual measurement result.

In alternative embodiments, the valid result of L1-RSRP measurement/BM serving as the ready indication may be a random L1-RSRP range within all possible L1-RSRP ranges used in the network. All possible L1-RSRP ranges used in the network may be defined in the communication standards or specifications. If the BS receives any L1-RSRP range that is one of all possible L1-RSRP ranges, the BS may assume that the UE becomes ready for L1-RSRP measurement/BM. In an aspect, the random L1-RSRP range may not be the lowest range of all possible ranges. In this case, any random L1-RSRP range that is one of all possible L1-RSRP ranges and is not the lowest one will serve as the ready indication.

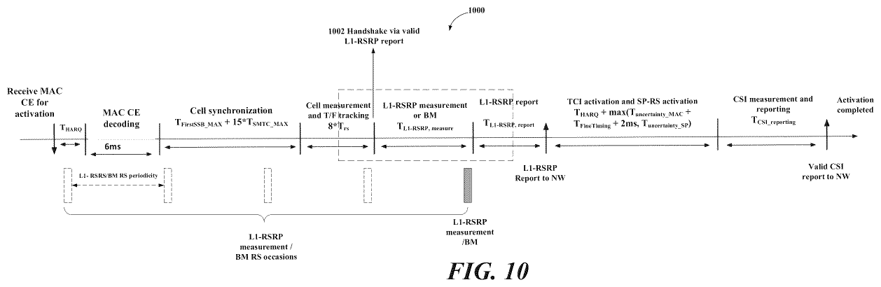

FIG. 10 illustrates another exemplary SCell activation procedure 1000 including a ready indication, according to embodiments disclosed herein.

As is shown in FIG. 10, the UE may be configured to send a valid result of L1-RSRP measurement/BM to the BS at 1002, when the UE becomes ready to perform L1-RSRP measurement/BM, which is before the UE performs any actual L1-RSRP measurement/BM. Upon receiving the this signaling, the BS may be configured to assume the UE is ready to perform L1-RSRP measurement/BM and accordingly configure, activate or transmit L1-RSRP measurement/BM RS to the UE.

According to alternative embodiments, the ready indication may be embodied as a new signaling that is sent from the UE to the BS. This signaling may be sent once the UE becomes ready for L1-RSRP measurement/BM.

In one embodiment, the ready indication may be sent via a signaling on a Physical Uplink Control Channel (PUCCH) transmission associated with a Primary Cell (PCell) or a Primary Secondary Cell (PSCell) or active PUCCH SCell. In another embodiment, the ready indication may be sent via a Layer 2 (L2) or Layer 3 (L3) signaling, such as a signaling on a MAC CE or RRC signaling on an active serving cell. Other types of signaling may also be used to carry the ready indication.

In optional embodiments, if cell synchronization or cell measurement of the UE fails, the ready indication may include a failure indicator associated with cell synchronization or cell measurement. That is, if cell synchronization and cell measurement of the UE successfully completes, the ready indication may be used to indicate the UE is ready for L1-RSRP measurement/BM. In this case, such ready indication may also be used as a request to the network for L1-RSRP measurement/BM RS. If cell synchronization or cell measurement of the UE fails, the ready indication may be used to indicate such failure to the network.

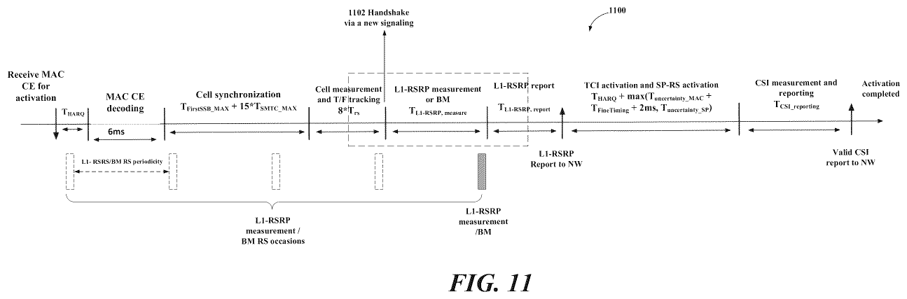

FIG. 11 illustrates another exemplary SCell activation procedure 1100 including a ready indication, according to embodiments disclosed herein.

As is shown in FIG. 11, the UE may be configured to send a new signaling to the BS at 1102, when the UE becomes ready to perform L1-RSRP measurement/BM. Upon receiving the this signaling, the BS may be configured to assume the UE is ready to perform L1-RSRP measurement/BM and accordingly configure, activate or transmit L1-RSRP measurement/BM RS to the UE.

According to preferred embodiments, the network may be configured to omit transmissions of L1-RSRP measurement/BM RS that are scheduled to occur before receiving the ready indication from the UE. Specifically, the network may configure periodic L1-RSRP measurement/BM RS occasions (and/or L1-RSRP measurement/BM report occasions) before the FR2 SCell activation, but does not actually transmit the configured L1-RSRP measurement/BM RS to the UE before it receives the ready indication from the UE. In other words, although a few L1-RSRP measurement/BM RS occasions may be scheduled to occur before the ready indication, the BS does not actually transmit any L1-RSRP measurement/BM RS to the UE at these scheduled occasions. Instead, the BS only transmits a L1-RSRP measurement/BM RS to the UE at configured occasions that occur after the ready indication. As is shown with the examples of FIGS. 7-11, the BS does not transmit any L1-RSRP measurement/BM RS at the occasions shown by dotted-line blocks, which occur before the BS receives the ready indication. The BS starts to transmit L1-RSRP measurement/BM RS at the occasion shown by the solid-line darkened block, which occurs after the BS receives the ready indication. In this manner, overhead associated with L1-RSRP measurement/BM RS before the UE becomes ready may be reduced.

In these embodiments, the UE may receive, from the network and before the FR2 SCell activation, configuration of periodic L1-RSRP measurement/BM RS occasions (and/or L1-RSRP measurement/BM report). The UE may also receive, from the network, an indicator that indicates the network will not transmit any configured L1-RSRP measurement/BM RS to the UE before the ready indication. Accordingly, the UE may not receive any configured L1-RSRP measurement/BM RS from the network before the ready indication. The UE will only receive and measure L1-RSRP measurement/BM RS that are transmitted after the ready indication.

The present disclosure provides enhancements to FR2 SCell activation. Specifically, devices and methods are provided with a handshake mechanism in FR2 SCell activation. The handshake mechanism is provided via a ready indication as discussed above, which allows the network to understand when the cell synchronization and measurement is completed at the UE and then the network could flexibly configure or activate or transmit the L1-RSRP measurement/BM RS for UE to perform L1-RSRP measurement/BM. By using this mechanism, L1-RSRP measurement/BM may be more flexible and the associated resources may be reduced.

It is readily understood that, the handshake mechanism disclosed herein may also apply to other FR2 SCell activation scenarios but not limited to the cases showing in FIGS. 4-11. For example, the handshake mechanism may also be used in FR2 SCell activation scenario of case 2-2-2 in FIG. 3.

Embodiments contemplated herein include an apparatus comprising means to perform one or more elements of the method 500 or 600 described herein. This apparatus may be, for example, an apparatus of a UE (such as a wireless device 202 that is a UE, as described herein), or an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method 500 or 600. This non-transitory computer-readable media may be, for example, a memory of a UE (such as a memory 206 of a wireless device 202 that is a UE, as described herein), or a memory of a base station (such as a network device 218 that is a base station, as described herein).

Embodiments contemplated herein include an apparatus comprising logic, modules, or circuitry to perform one or more elements of the method 500 or 600. This apparatus may be, for example, an apparatus of a UE (such as a wireless device 202 that is a UE, as described herein) or an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method 500 or 600. This apparatus may be, for example, an apparatus of a UE (such as a wireless device 202 that is a UE, as described herein) or an apparatus of a base station (such as a network device 218 that is a base station, as described herein).

Embodiments contemplated herein include a signal as described in or related to one or more elements of the method 500 or 600.

Embodiments contemplated herein include a computer program or computer program product comprising instructions, wherein execution of the program by a processor is to cause the processor to carry out one or more elements of the method 500 or 600. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein) or a memory of a base station (such as a network device 218 that is a base station, as described herein).

At least the following embodiments are provided in the disclosure.

According to some embodiments disclosed herein, a user equipment (UE) is disclosed, comprising: at least one antenna; at least one radio coupled to the at least one antenna; and a processor coupled to the at least one radio; wherein the processor is configured to, during Frequency Range 2 (FR2) Secondary Cell (SCell) activation: send, to a network, a ready indication that the UE is ready to perform Layer 1-Reference Signal Receiving Power (L1-RSRP) measurement/beam measurement (BM); and receive a L1-RSRP measurement/BM Reference Signal (RS) from the network.

In some of these embodiments, the processor is further configured to: determine that the UE is ready to perform L1-RSRP measurement/BM upon completion of cell synchronization and cell measurement during the FR2 SCell activation.

In some of these embodiments, the processor is configured to: send the ready indication by reporting an out-of-range (OOR) from the UE to the network, wherein the OOR is not reported to the network before the UE is ready to perform L1-RSRP measurement/BM.

In some of these embodiments, the processor is configured to: send the ready indication by reporting a lowest valid L1 Synchronization Signal Reference Signal Received Power (SS-RSRP) range from the UE to the network, wherein the lowest valid L1 SS-RSRP range is not reported to the network before the UE is ready to perform L1-RSRP measurement/BM.

In some of these embodiments, the ready indication is reported via a valid Chanel Quality Index (CQI) to the network, wherein the valid CQI is reported to the network once the UE is ready to perform L1-RSRP measurement/BM.

In some of these embodiments, the valid CQI is selected from at least one of: a specific CQI index that is preconfigured by the network; a predefined CQI index; or a random CQI index.

In some of these embodiments, the processor is configured to: send the ready indication via a signaling on a Physical Uplink Control Channel (PUCCH) transmission associated with a Primary Cell (PCell) or a Primary Secondary Cell (PSCell) or active PUCCH SCell.

In some of these embodiments, the processor is configured to: send the ready indication via a MAC CE or RRC signaling on an active serving cell.

In some of these embodiments, the processor in configured to: if cell synchronization or cell measurement of the UE fails, include a failure indicator associated with the cell synchronization or the cell measurement in the ready indication.

In some of these embodiments, the processor is configured to: send the ready indication by reporting a valid result of L1-RSRP measurement/BM, wherein the valid result of L1-RSRP measurement/BM is not based on measurement of an actual L1-RSRP measurement/BM RS from the network.

In some of these embodiments, the valid result of L1-RSRP measurement/BM is selected from at least one of: a specific L1-RSRP range that is preconfigured by the network; a predefined L1-RSRP range; or a random L1-RSRP range.

In some of these embodiments, the processor in configured to: receive, from the network and before the FR2 SCell activation, configuration of periodic L1-RSRP measurement/BM RS occasions; and not receive any configured L1-RSRP measurement/BM RS from the network before the ready indication.

In some of these embodiments, the processor in configured to: receive, from the network, an indicator that indicates the network will not transmit any configured L1-RSRP measurement/BM RS to the UE at the configured L1-RSRP measurement/BM RS occasions before receiving the ready indication from the UE.

According to some embodiments disclosed herein, a method is disclosed, comprising: by a user equipment (UE) and during FR2 Secondary Cell (SCell) activation, sending, to a network, a ready indication that the UE is ready to perform Layer 1-Reference Signal Receiving Power (L1-RSRP)/beam measurement (BM); and receiving a L1-RSRP measurement/BM Reference Signal (RS) from the network.

According to some embodiments disclosed herein, a base station (BS) is disclosed, comprising: at least one antenna; at least one radio coupled to the at least one antenna; and a processor coupled to the at least one radio; wherein the processor is configured to, during FR2 Secondary Cell (SCell) activation: receive from a user equipment (UE), a ready indication that the UE is ready to perform Layer 1-Reference Signal Receiving Power (L1-RSRP)/beam measurement (BM); and after receiving the ready indication, transmit a L1-RSRP measurement/BM Reference Signal (RS) to the UE for use with L1-RSRP measurement/BM.

In some of these embodiments, the processor is configured to receive the ready indication via one of: an out-of-range (OOR) reported from the UE to the network, wherein the OOR is not reported to the network before the UE is ready to perform L1-RSRP measurement/BM; a lowest valid L1 Synchronization Signal Reference Signal Received Power (SS-RSRP) range reported from the UE to the network, wherein the lowest valid L1 SS-RSRP range is not reported to the network before the UE is ready to perform L1-RSRP measurement/BM; a valid Chanel Quality Index (CQI) reported from the UE to the network, wherein the valid CQI is reported to the network once the UE is ready to perform L1-RSRP measurement/BM; or a valid result of L1-RSRP measurement/BM reported from the UE to the network, wherein the valid result of L1-RSRP measurement/BM is not based on measurement of an actual L1-RSRP measurement/BM RS from the network.

In some of these embodiments, the processor is configured to receive the ready indication via one of: a signaling on a Physical Uplink Control Channel (PUCCH) transmission associated with a Primary Cell (PCell) or a Primary Secondary Cell (PSCell) or active PUCCH SCell; or a MAC CE or RRC signaling on an active serving cell.

In some of these embodiments, the processor is configured to: configure periodic L1-RSRP measurement/BM RS occasions before the FR2 SCell activation; and not transmit any L1-RSRP measurement/BM RS to the UE at the configured L1-RSRP measurement/BM RS occasions before receiving the ready indication from the UE.

In some of these embodiments, the processor is configured to: transmit, to the UE, an indicator that indicates the BS will not transmit any L1-RSRP measurement/BM RS to the UE at the configured L1-RSRP measurement/BM RS occasions before receiving the ready indication.

According to some embodiments disclosed herein, a method is disclosed, comprising: by a base station (BS) and during FR2 Secondary Cell (SCell) activation, receive from a user equipment (UE), a ready indication that the UE is ready to perform Layer 1-Reference Signal Receiving Power (L1-RSRP)/beam (BM) measurement; and after receiving the ready indication, transmit a L1-RSRP measurement/BM Reference Signal (RS) to the UE for use with L1-RSRP measurement/BM.

According to some embodiments disclosed herein, an apparatus is disclosed, comprising: one or more processors and one or more computer-readable media comprising instructions that, when executed by the one or more processors, cause the one or more processors to perform the method of embodiment 14 or 20.

According to some embodiments disclosed herein, a computer-readable media is disclosed, comprising instructions that, when executed by one or more processors, cause the one or more processors to perform the method of embodiment 14 or 20.

According to some embodiments disclosed herein, a computer program product is disclosed, comprising computer programs that, when executed by one or more processors, cause the one or more processors to perform the method of embodiment 14 or 20.

According to some embodiments disclosed herein, an apparatus is disclosed, comprising means for performing the method of embodiment 14 or 20.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
at least one antenna;
at least one radio coupled to the at least one antenna; and
a processor coupled to the at least one radio;
wherein the processor is configured to, during Frequency Range 2 (FR2) Secondary Cell (SCell) activation:
send, to a network and via the at least one radio, a ready indication that the UE is ready to perform Layer 1-Reference Signal Receiving Power (L1-RSRP) measurement/beam measurement (BM); and
receive, via the at least one radio, a L1-RSRP measurement/BM Reference Signal (RS) from the network.

2. The UE of claim 1, wherein the processor is further configured to:
determine that the UE is ready to perform L1-RSRP measurement/BM upon completion of cell synchronization and cell measurement during the FR2 SCell activation.

3. The UE of claim 1, wherein the processor is configured to:
send the ready indication by reporting an out-of-range (OOR) from the UE to the network, wherein the OOR is not reported to the network before the UE is ready to perform L1-RSRP measurement/BM.

4. The UE of claim 1, wherein the processor is configured to:
send the ready indication by reporting a lowest valid L1 Synchronization Signal Reference Signal Received Power (SS-RSRP) range from the UE to the network, wherein the lowest valid L1 SS-RSRP range is not reported to the network before the UE is ready to perform L1-RSRP measurement/BM.

5. The UE of claim 1, wherein the processor is configured to:
send the ready indication by reporting a valid Channel Quality Index (CQI) to the network, wherein the valid CQI is reported to the network once the UE is ready to perform L1-RSRP measurement/BM.

6. The UE of claim 5, wherein the valid CQI is selected from at least one of:
a specific CQI index that is preconfigured by the network;
a predefined CQI index; or
a random CQI index.

7. The UE of claim 1, wherein the processor is configured to:
send the ready indication via a signaling on a Physical Uplink Control Channel (PUCCH) transmission associated with a Primary Cell (PCell) or a Primary Secondary Cell (PSCell) or an active PUCCH SCell.

8. The UE of claim 1, wherein the processor is configured to:
send the ready indication via a Medium Access Control Control Element (MAC CE) or Radio Resource Control (RRC) signaling on an active serving cell.

9. The UE of claim 7, wherein the processor is further configured to:
if cell synchronization or cell measurement of the UE fails, include a failure indicator associated with the cell synchronization or the cell measurement in the ready indication.

10. The UE of claim 1, wherein the processor is configured to:
send the ready indication by reporting a valid result of L1-RSRP measurement/BM, wherein the valid result of L1-RSRP measurement/BM is not based on measurement of an actual L1-RSRP measurement/BM RS from the network.

11. The UE of claim 10, wherein the valid result of L1-RSRP measurement/BM is selected from at least one of:
a specific L1-RSRP range that is preconfigured by the network;
a predefined L1-RSRP range; or
a random L1-RSRP range.

12. The UE of claim 1, wherein the processor in is further configured to:
receive, from the network and before the FR2 SCell activation, configuration of periodic L1-RSRP measurement/BM RS occasions; and
not receive any configured L1-RSRP measurement/BM RS from the network before the ready indication.

13. The UE of claim 12, wherein the processor in-is further configured to:
receive, from the network, an indicator that indicates the network will not transmit any configured L1-RSRP measurement/BM RS to the UE at the configured L1-RSRP measurement/BM RS occasions before receiving the ready indication from the UE.

14. A processor for a User Equipment (UE), configured to perform operations comprising:
during Frequency Range 2 (FR2) Secondary Cell (SCell) activation,
sending, to a network, a ready indication that the UE is ready to perform Layer 1-Reference Signal Receiving Power (L1-RSRP)/beam measurement (BM); and
receiving a L1-RSRP measurement/BM Reference Signal (RS) from the network.

15. A processor for a base station (BS), configured to perform operations comprising:
during Frequency Range 2 (FR2) Secondary Cell (SCell) activation,
receiving, from a user equipment (UE), a ready indication that the UE is ready to perform Layer 1-Reference Signal Receiving Power (L1-RSRP)/beam measurement (BM); and
after receiving the ready indication, sending a L1-RSRP measurement/BM Reference Signal (RS) to the UE for use with L1-RSRP measurement/BM.

16. The processor of claim 15, wherein the processor is configured to receive the ready indication via one of:
an out-of-range (OOR) reported from the UE, wherein the OOR is not reported before the UE is ready to perform L1-RSRP measurement/BM;
a lowest valid L1 Synchronization Signal Reference Signal Received Power (SS-RSRP) range reported from the UE, wherein the lowest valid L1 SS-RSRP range is not reported before the UE is ready to perform L1-RSRP measurement/BM;
a valid Channel Quality Index (CQI) reported from the UE, wherein the valid CQI is reported once the UE is ready to perform L1-RSRP measurement/BM; or
a valid result of L1-RSRP measurement/BM reported from the UE, wherein the valid result of L1-RSRP measurement/BM is not based on measurement of an actual L1-RSRP measurement/BM RS.

17. The processor of claim 15, wherein the processor is configured to receive the ready indication via one of:
a signaling on a Physical Uplink Control Channel (PUCCH) transmission associated with a Primary Cell (PCell) or a Primary Secondary Cell (PSCell) or an active PUCCH SCell; or
a Medium Access Control Control Element (MAC CE) or Radio Resource Control (RRC) signaling on an active serving cell.

18. The processor of claim 15, wherein the operations further comprise:
configuring periodic L1-RSRP measurement/BM RS occasions before the FR2 SCell activation; and
not sending any L1-RSRP measurement/BM RS to the UE at the configured L1-RSRP measurement/BM RS occasions before receiving the ready indication from the UE.

19. The BS of claim 18, wherein the operations further comprise:
sending, to the UE, an indication that no L1-RSRP measurement/BM RS will be sent to the UE at the configured periodic L1-RSRP measurement/BM RS occasions before receiving the ready indication.

20. (canceled)

21. The processor of claim 14, wherein the ready indication is sent to the network upon completion of cell synchronization and cell measurement during the FR2 SCell activation.
